(19) United States
(12) Patent Application Publication
(10) Pub. No.: US 2011/0267231 A1
(43) Pub. Date: Nov. 3, 2011

(54) Cellular Antenna Phase Shifter Positioning Using Motorized Torque Lever

(75) Inventors: Quoc M. Le, Plano, TX (US); Steve Schmutzler, Homer Glen, IL (US)

(73) Assignee: Andrew LLC, Hickory, NC (US)

(21) Appl. No.: 12/771,826

(22) Filed: Apr. 30, 2010

(51) Int. Cl. H01Q 3/00; H02K 7/116; H02P 8/00; F16H 57/00

(52) U.S. Cl. 342/359; 74/412 R; 74/421 A; 310/83; 318/696

(57) ABSTRACT

An actuator providing improved torque, control, and reduced motor and actuator size is provided. An actuator according to one example may include a base plate, a stationary ring gear on the base plate, the ring gear having an arc of substantially less than a conventional full circle ring gear, a pivot assembly and a drive shaft. In one example, the ring gear is approximately half a circle. The pivot assembly may be pivotally mounted on the base plate. The pivot assembly may also have a control board, a stepper motor and a drive gear coupled to an output shaft of the stepper motor, the drive gear mounted on the pivot assembly such that the drive gear engages the stationary ring gear. In one example, the stepper motor is coupled to the drive gear via a worm gear, spur gear, and a shaft. In another example, the drive gear is mounted directly on the output shaft of the stepper motor. The actuator also includes a drive shaft having an axis parallel to a pivot of the pivot assembly.

### BACKGROUND

Wireless mobile communication networks continue to evolve given the increased traffic demands on the networks, the expanded coverage areas for service and the new systems being deployed. Cellular (“wireless”) communications networks rely on a network of base station antennas for connecting cellular devices, such as cellular telephones, to the wireless network. Many base station antennas include a plurality of radiating elements in a linear array. Various attributes of the antenna array, such as beam elevation angle, beam azimuth angle, and half power beam width may be adjusted by electrical-mechanical controllers. See, for example, U.S. Pat. Nos. 6,573,875 and 6,603,436, both of which are incorporated by reference. For example, with respect to U.S. Pat. No. 6,573,875, a plurality of radiating elements may be provided in an approximately vertical alignment. A feed network may be provided to supply each of the radiating elements with a signal. The phase angle of the signals provided to the radiating elements may be adjusted to cause a radiated beam angle produced by the antenna array to tilt up or down from a nominal or default beam angle.

Phase angles may be adjusted by mechanical phase shifters. In the example of the '875 patent, phase shifters are coupled by a common mechanical linkage. An expected phase angle may be ascertained from markings on a linearly-reciprocal linkage rod or by a sensor in a linear motion electro-mechanical actuator located off the antenna panel extending beyond a bottom edge of the panel. However, known linear pushrod actuators, while having certain advantages, are not always well adapted to actuating variable elements such as phase shifters. Many antenna variable elements require rotational actuation, so a mechanism must be included to translate linear motion to rotational motion. Rotational stepper motors are also known, however, when selected to produce sufficient torque to drive the variable elements such motors may be undesirably large. Smaller motors may be used with gear reduction arrangements to multiply torque, however, known gear reduction arrangements may occupy undesirably large amounts of space.

### SUMMARY

An actuator providing improved torque, control, and reduced motor and actuator size is provided. An actuator according to one example of the present invention may include a base plate, a stationary ring gear on the base plate, the ring gear having an arc of substantially less than a conventional full circle ring gear, a pivot assembly and a drive shaft. In one example, the ring gear is approximately half a circle. The pivot assembly may be pivotally mounted on the base plate. The pivot assembly may also have a control board, a stepper motor and a drive gear coupled to an output shaft of the stepper motor, the drive gear mounted on the pivot assembly such that the drive gear engages the stationary ring gear. In one example, the stepper motor is coupled to the drive gear via a worm gear, spur gear, and a shaft. In another example, the drive gear is mounted directly on the output shaft of the stepper motor. The actuator also includes a drive shaft having an axis parallel to a pivot of the pivot assembly.

The drive shaft may be formed as part of the pivot assembly. For example, the pivot assembly may further include a pivot bracket, wherein the control board is mounted on the pivot bracket, and the pivot bracket is pivotally mounted on the base plate at a point comprising a center of a circle defined by the stationary ring gear. The drive shaft may be formed as part of the pivot bracket.

In various examples, the controller board may include several components, including a controller, a motor driver, and an accelerometer. The controller may be responsive to commands that conform with industry standards, such as AISG. The controller may be coupled to the accelerometer and coupled to ASIG connectors, and the motor driver may be coupled to the controller and to the stepper motor.

In another example, the actuator of the present invention is incorporated on a panel antenna. The panel antenna may include a plurality of radiating elements, an input, a first feed network coupling the input to a first set of dipoles of the plurality of radiating elements, the first feed network comprising a plurality of transmission lines and at least a first variable element, the first variable element including a rotatable component; and an actuator according to one or more examples of the present invention, where the drive shaft of the actuator physically engages the rotatable component of the variable element. The panel antenna may also include a second feed network, where one or more variable elements of the second feed network are also driven by the actuator, typically by a cross link.

In another example, an actuator may include a base plate, a stationary ring gear, on the base plate, and a pivot assembly. The ring gear having an arc of approximately 180°. The pivot assembly is pivotally mounted on the base plate. The pivot assembly may include a pivot bracket, a control board, and a stepper motor and drive gear. The pivot bracket comprises a drive shaft having an axis parallel to a pivot of the pivot assembly. The control board is mounted on the pivot bracket. The control board also includes an accelerometer, a controller coupled to the accelerometer, and a motor driver coupled to the controller. The drive gear is mounted on an output shaft of the stepper motor, and the stepper motor is coupled to the motor driver and mounted on the pivot bracket such that the drive gear engages the stationary ring gear. The controller is configured to obtain information from the accelerometer indicative of a physical angle of the pivot assembly, and the controller is further configured to operate the stepper motor until the pivot assembly reaches a desired physical angle with respect to vertical.

### BRIEF DESCRIPTION OF THE DRAWINGS

FIG. 1 is a schematic diagram of a panel antenna.

FIG. 2 is an illustration of a pair of phase shifters.

FIG. 3 is a perspective drawing of a portion of a panel antenna having an actuator according to the present invention.

FIG. 4 is a perspective view of an actuator according to the present invention with the cover removed for clarity.

FIG. 5 is a bottom view of an actuator according to the present invention.

FIG. 6 is a top view of a first example pivot assembly according to the present invention.

FIG. 7 is a bottom view of the first example of a pivot assembly according to the present invention.

FIG. 8 is a top view of a second example of a pivot assembly according to the present invention.

FIG. 9 is a bottom view of the second example of a pivot assembly according to the present invention.

### DETAILED DESCRIPTION

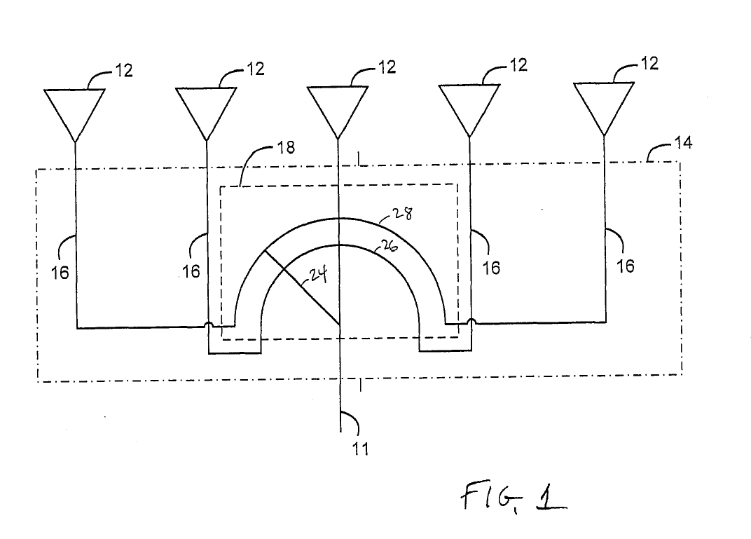

Referring to FIG. 1, a typical antenna array 10 may include an input 11, a plurality of radiating elements 12 and a feed network 14 coupling the input 11 to the radiating elements 12. A schematic diagram of a typical feed network 14 for an antenna array 10 is provided in FIG. 1. The feed network 14 may include a plurality of transmission lines 16 and one or more variable elements 18. The transmission lines 16 have a nominal impedance which may be selected to match an impedance of a RF line that couples the antenna array 10 to a Low Noise Amplifier (not shown). Transmission lines 16 may be implemented as microstrip transmission lines, coaxial cables, or other impedance-controlled transmission media. The variable elements 18 may comprise one or more phase shifters, power dividers, a combination of the two, or another type of variable element. The variable elements 18 may comprise differential variable elements. In one example, first and second feed networks 14 are provided, with a first feed network 14 driving a first set of dipoles on radiating elements 12, and a second feed network 14 driving a second set of dipoles on radiating elements 12.

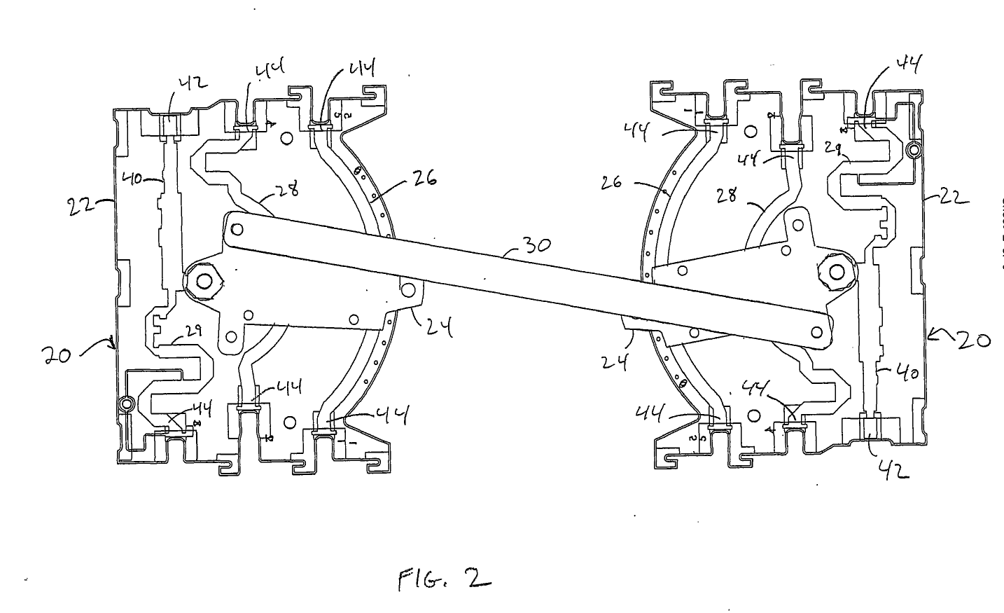

In one example of the invention, the variable elements 18 comprise rotating-wiper type phase shifters 20. Referring to FIG. 2, phase shifter 20, in one example, may be implemented with first and second printed circuit boards (PCBs). In one illustrated example, the first PCB may comprise a stationary PCB 22, and the second PCB may comprise a rotatable wiper PCB 24.

The stationary PCB 22 includes a plurality of transmission line traces 26, 28. The transmission line traces 26, 28 are generally arcuate. The transmission line traces 26, 28 may be disposed in a serpentine pattern to achieve a longer effective length. In an illustrated example, there are two transmission line traces 26, 28 on the stationary PCB 22, one transmission line trace 26 being disposed along an outer circumference of a PCB 22, and one transmission line trace 28 being disposed on a shorter radius concentrically within the outer transmission line trace 26.

In the illustrated example, the stationary PCB 22 may include one or more input traces 40 leading from an input pad 42 near an edge of the stationary PCB 22 to where the pivot of the wiper PCB 24 is located. (The use of “input” and “output” herein refers to the radio frequency signal path as the panel antenna transmits. Radio frequency signals received by the panel antenna flow in the reverse direction.) Electrical signals on an input trace 40 are coupled to the wiper PCB 24. The wiper PCB 24 couples the electrical signals to the transmission line traces 26, 28. Transmission line traces 26, 28 may be coupled to output pads to which a coaxial cable may be connected. Alternatively, the stationary PCB 22 may be coupled to stripline transmission lines on a panel without additional coaxial cabling. As the wiper PCB 24 moves, an electrical length from the wiper PCB 24 to each output pad 44, and therefore each radiating element served by the transmission lines 26, 28 changes. For example, as the wiper PCB 24 moves to shorten the electrical length from the input transmission line trace 40 to a first radiating element, the electrical length from the input transmission line trace end to a second radiating element increases by a corresponding amount. In the example illustrated in FIG. 2, an additional transmission line trace 29 is included on stationary PCB 22. Transmission line trace 29 carries an unshifted signal.

In one example illustrated in FIG. 2, two phase shifters 20 are illustrated. The wiper PCBs 24 are mechanically coupled by wiper link 30 such that the wiper arm PCBs move in unison.

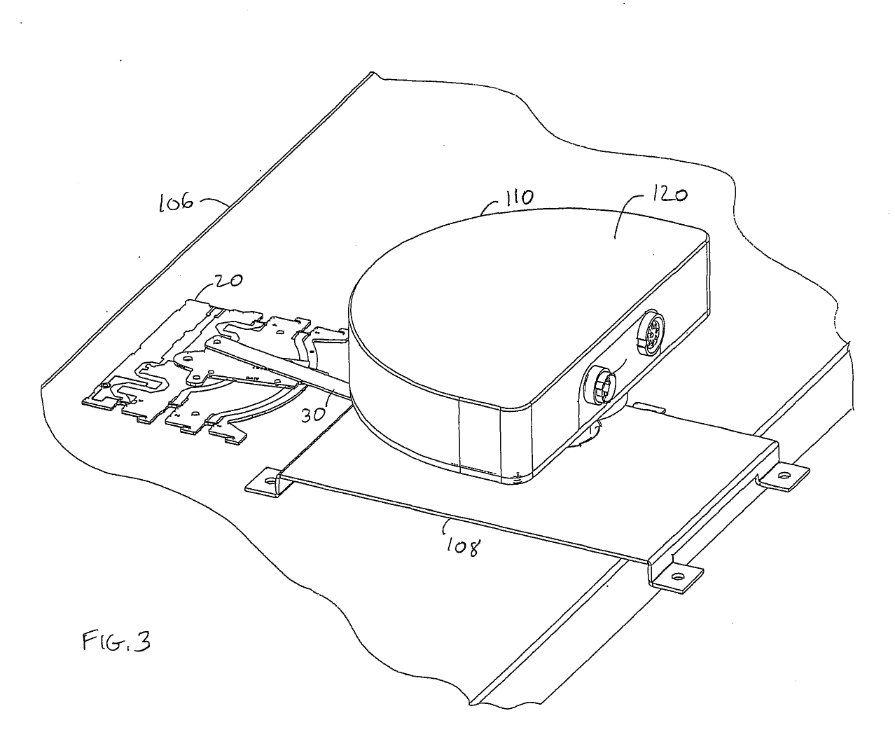

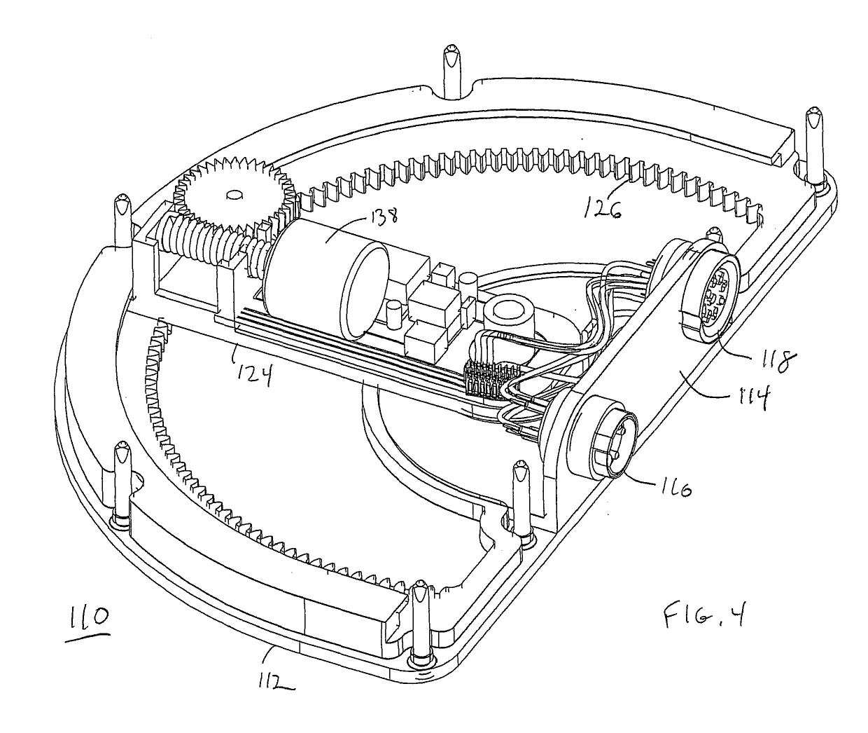

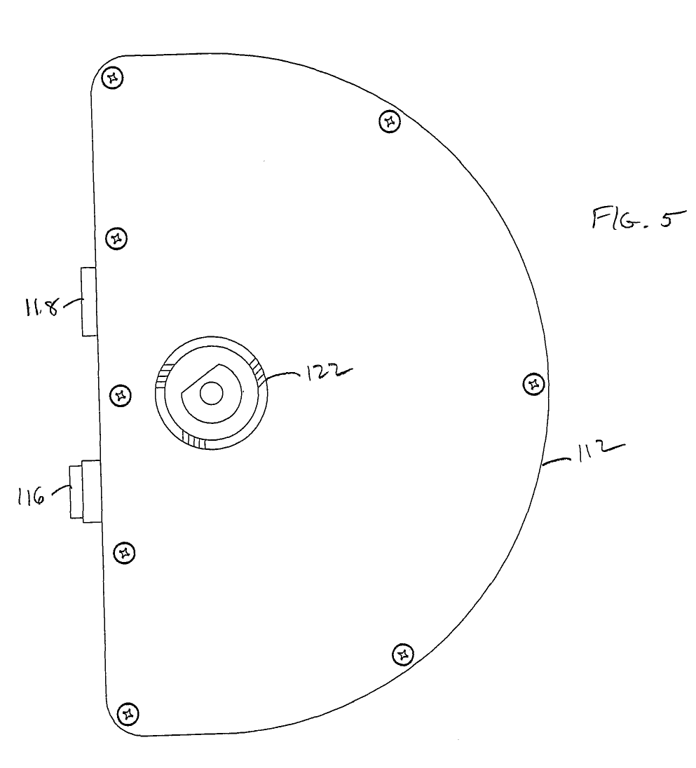

Referring to FIG. 3, in one embodiment of the present invention, an actuator 110 is directly coupled to one of the phase shifters 20. The actuator 110 is mounted on an actuator mount 108, which is mounted to a radome back panel (not shown for clarity). The phase shifters 20 are mounted on a reflector 106. Referring to FIG. 4 and FIG. 5, the actuator 110 comprises a baseplate 112, a connector bracket 114, a top cover 120, a drive shaft 122 and a pivot assembly 124. The connector bracket 114 may comprise a molded AISG connector bracket. Male AISG connector 116 and female AISG connector 118 may be installed on the connector bracket 114. A ring gear 126 may be attached to the baseplate 112. In the illustrated example, the baseplate 112 is semi-circular and the ring gear 126 comprises a half ring gear, with gear teeth on an inner circumference of the gear. In this regard the ring gear 126 comprises only a portion of a conventional circular ring gear. The ring gear 126 may also include additional supporting structure which connects ends of the ring gear 126 to provide additional mechanical strength and facilitate mounting of the ring gear 126 on the baseplate 112 in an appropriate orientation. The baseplate 112 may be thermo molded plastic, metal, or any other suitable material. The ring gear 126 may be formed integrally with the baseplate 112, for example, the ring gear 126 may be molded as a single unit with the baseplate 112. Alternatively, the ring gear 126 may be separately formed and fixedly attached to the baseplate 112.

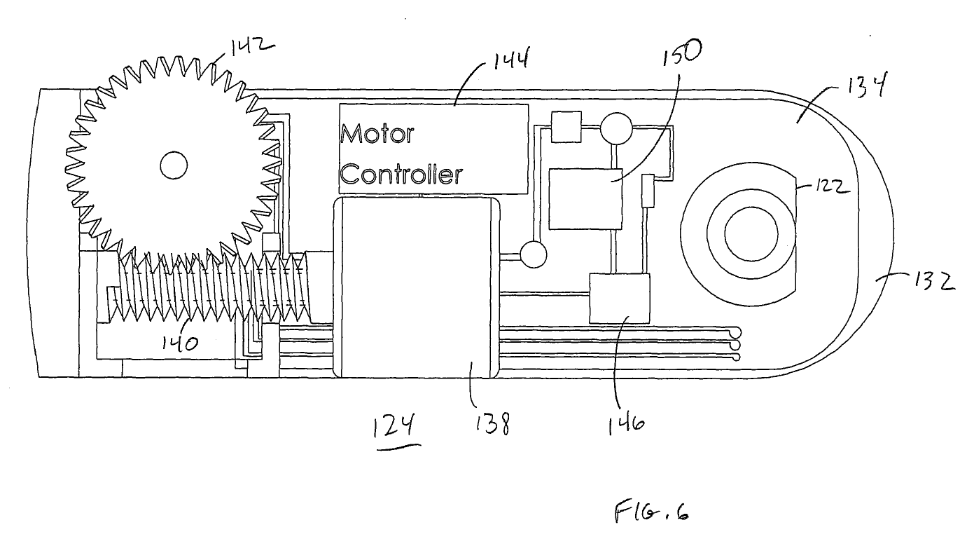

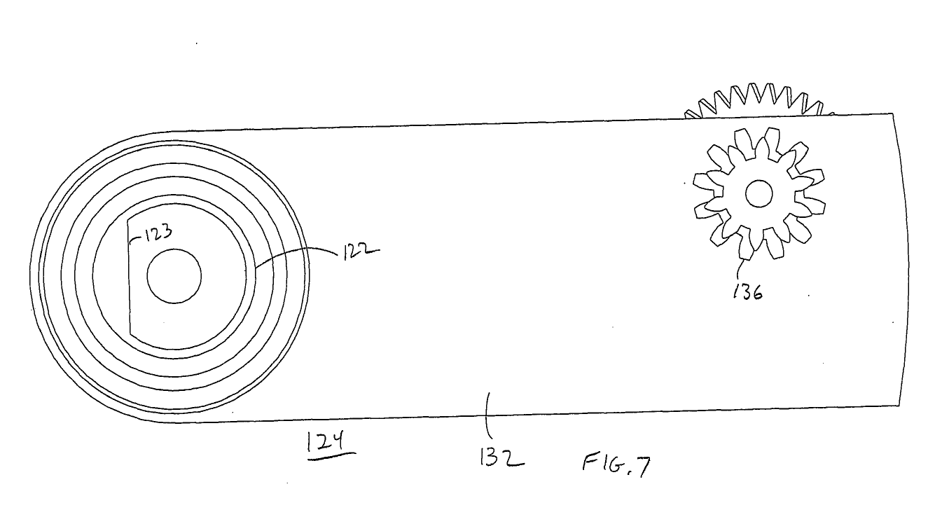

Referring to FIGS. 4, 6 and 7, the pivot assembly 124 includes a pivot bracket 132, a control board 134, drive gear 136, and a stepper motor 138. Operation of the stepper motor 138 is controlled by the control board 134, and the stepper motor 138 and control board 134 are mounted on the pivot bracket 132. The pivot bracket 132 engages the drive shaft 122. In one example, the drive shaft 122 may be molded as a unitary piece with pivot bracket 132. In a preferred example, an output shaft of stepper motor 138 drives worm gear 140. Worm gear 140 meshes with and drives spur gear 142. A shaft couples spur gear 142 to drive gear 136. This arrangement reduces the likelihood that the variable elements will be able to back-drive the stepper motor 138.

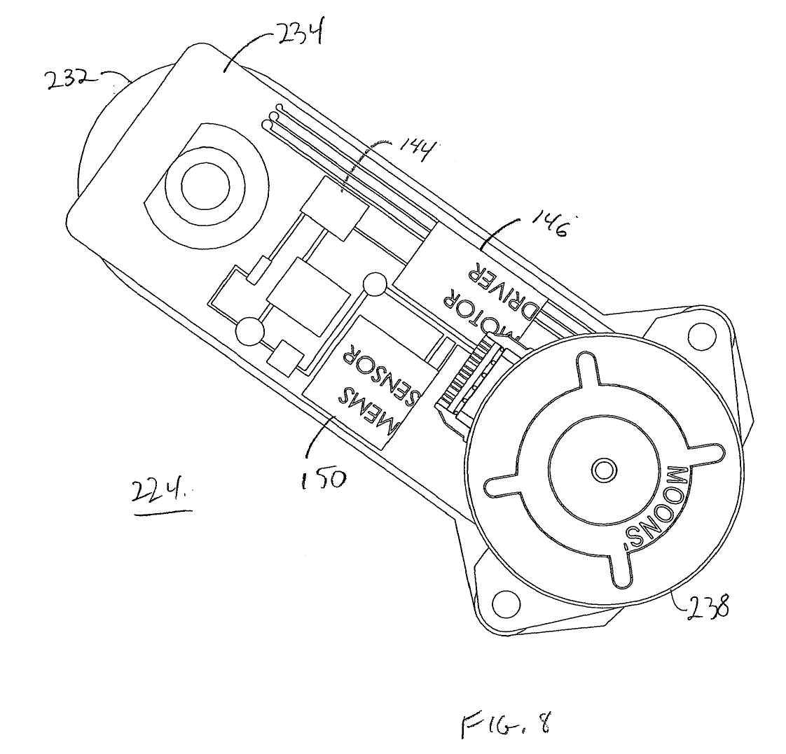

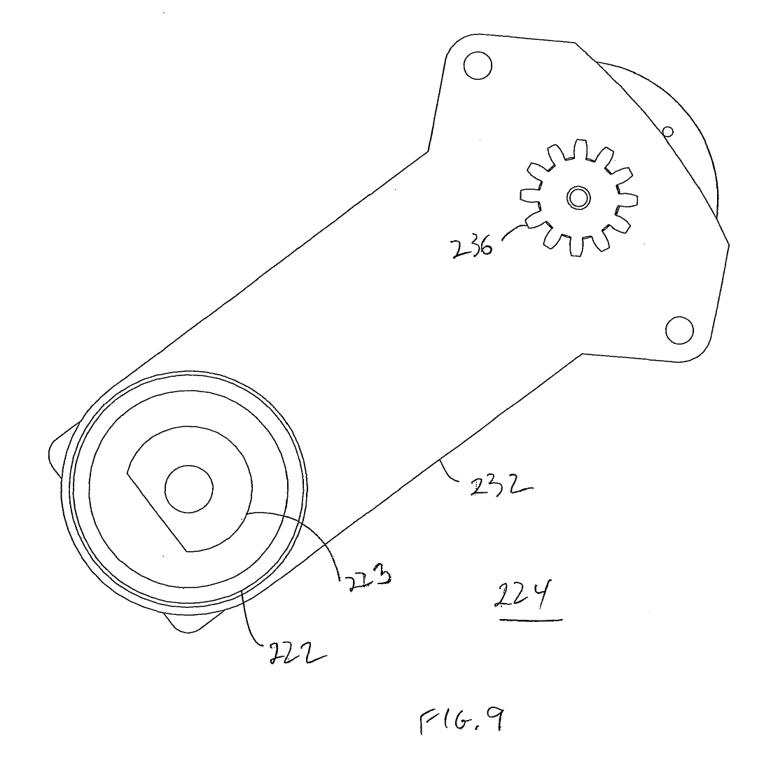

In an alternate example, referring to pivot assembly 224 on FIGS. 8 and 9, stepper motor 238 and control board 234 are on one side of the pivot bracket 232, and the drive gear 236 is on the other side of the pivot bracket 232. This alternate example has fewer moving parts and allows good transfer of rotational force, because a rotor shaft of the stepper motor 238 passes through the pivot bracket 232. The stepper motor 238 may include additional securing brackets and fasteners. Additional alternate physical relationships between the stepper motor and the drive gear may be implemented without departing from the scope of the invention.

The ring gear 126 is located such that a circle defined by the radius of the ring gear 126 is concentric with the drive shaft 122. Additionally, the length of the pivot bracket 132 and the location of the drive gear 136 are dimensioned such that the drive gear 136 engages the ring gear 126, and, as the stepper motor 138 is operated, the drive gear 136 moves the pivot board through an arc defined by the ring gear 126 and the radius of the pivot bracket 132. In the illustrated example, the rotation of the pivot board is approximately 180 degrees. Other amounts of rotation may be implemented without departing from the invention.

The male AISG connector 116 and the female AISG connector 118 are coupled to the control board 134. The control board 134 includes a controller 144, which may be a microprocessor or microcontroller, and a motor driver 146. These devices are configured to operate the stepper motor 138. The controller may also be configured to receive and transmit commands and information according to AISG protocols.

In one example, the control board 134 includes an accelerometer 150, such as a 3-axis MEMS accelerometer 150. The controller 144 on the control board 134 may be configured to read register information from the accelerometer, thereby determining the orientation of the pivot assembly 124, and therefore drive shaft 122 position. From this, phase adjuster position may be determined.

Preferably, the accelerometer 150 comprises a multiple-axis digital accelerometer, such as Digital Accelerometer ADXL345, from Analog Devices, Inc. In this example, the accelerometer 150 is a digital 3-axis accelerometer. However, other accelerometers may be acceptable in alternate embodiments. The accelerometer provides angle information for the three axes of rotation as serial data. In one example, the serial data conforms to the I²C digital interface. X-axis data, y-axis data, and z-axis data may be obtained by reading appropriate registers in the accelerometer 150. The controller 144 interfaces with the accelerometer 150 and reads the data registers.

The accelerometer 150 is mounted on the wiper control board 134 such that it may detect a physical angle of the control board 134 with respect to vertical. Control board 134 physical angle 0 may be determined by a first axis of the accelerometer 150. If control board 134 angle with respect to vertical is the only angle to be determined, the solution may be had with a single axis of the accelerometer 150 and the following trigonometry relationship:

V_{OUTX}=V_{OFF}+S sin θ

Where V_{OUTX} is the voltage output from the X-axis of the accelerometer, V_{OFF} is the an offset voltage and S is the sensitivity of the accelerometer. The acceleration on the x-axis due to gravity is:

A_{X}=(V_{OUTX}−V_{OFF})÷S

In this case, the solution for control board 134 angle is:

θ=sin⁻¹(Ax)

In another example, the actuator is mounted such that the axis of rotation of the default angle of the panel antenna is on a different axis (e.g., the y-axis) from an axis of rotation of the control board 134.

In an alternative embodiment, a rotary potentiometer may be attached to the drive shaft 122 and coupled to the controller. In another alternate embodiment, pivot assembly 124 position sensing may be accomplished with pressure sensitive potentiometer tape extending the length of the ring gear 126.

In one example, the actuator 110 is directly coupled to a first phase shifter. The first phase shifter may be mechanically linked to additional phase shifters such that, by driving the first phase shifter, all phase shifters are driven simultaneously.

The pivot bracket 132 may be rotationally fixed to the drive shaft 122. The pivot bracket 132 and drive shaft 122 may be arranged such that they fit together in only one orientation, so that a risk of misalignment of the drive shaft 122 and pivot assembly 124 is minimized. In one example, the drive shaft 122 may have a D-shaped output side 123, so that, once again, a risk of misalignment is minimized when the drive shaft 122 is connected to a phase shifter or linkage to operate one or more phase shifters.

In operation, commands indicating a desired antenna beam downtilt angle are received via the AISG connector. The controller determines an appropriate actuator 110 position (for example, a position of the pivot assembly 124) that corresponds to the desired beam downtilt angle. The controller may determine the appropriate actuator position by retrieving from a look-up table a physical actuator 110 position that corresponds to a desired beam downtilt angle. The relationship between downtilt angle and pivot assembly 124 angle actuator 110 position may have been previously determined empirically and stored in the look-up table in the firmware for the controller. The controller then operates the stepper motor 138 until the pivot assembly 124 reaches the appropriate orientation. In the case of position being determined by an accelerometer, registers providing x-axis, y-axis, and z-axis information may be read periodically while the motor is moving the pivot assembly 124. The registers may also be read when the motor is not in operation to determine actuator 110 position, true mechanical tilt of the panel antenna, or for other reasons.

Various examples of the actuator 110 described herein benefit from improve torque. The torque of the stepper motor 138 is multiplied by the lever arm of the pivot bracket 132. Thus, for a desired torque to operate a series of phase shifters, a proportionately smaller motor may be used. Additionally, the present invention requires only half a ring gear 126, and that half ring gear 126 is stationary while the motor moves. This difference from conventional reduction gearing means that the actuator 110 takes up less space than a conventional reduction gear setup. If, for example, the motor were fixed and the ring gear 126 rotated, it would require 360 degrees of clearance to achieve 180 degrees of rotation.

What is claimed is:

1. An actuator, comprising:
a. a base plate;
b. a stationary ring gear, on the base plate, the ring gear having an arc of substantially less than 360°;
c. a pivot assembly, pivotally mounted on the base plate, the pivot assembly having a control board, a stepper motor and a drive gear coupled to an output shaft of the stepper motor, the drive gear mounted on the pivot assembly such that the drive gear engages the stationary ring gear; and
d. a drive shaft having an axis parallel to a pivot of the pivot assembly.

2. The actuator of claim 1, where the pivot assembly further comprises a pivot bracket, wherein the control board is mounted on the pivot bracket, and the pivot bracket is pivotally mounted on the base plate at a point comprising a center of a circle defined by the stationary ring gear.

3. The actuator of claim 1, wherein the controller board further comprises a controller and a motor driver.

4. The actuator of claim 1, wherein the controller board further comprises an accelerometer.

5. The actuator of claim 1, wherein the pivot assembly further comprises a worm gear and a spur gear, wherein the worm gear is located on the output shaft of the stepper motor, the worm gear engages the spur gear, and the spur gear is coupled to the drive gear.

6. The actuator of claim 1, wherein the stationary ring gear has an arc of approximately 180°.

7. The actuator of claim 1, wherein actuator further includes AISG connectors, and wherein the control board further includes a controller coupled to the ASIG connectors and a motor driver coupled to the controller and to the stepper motor.

8. The actuator of claim 1, wherein actuator further includes AISG connectors, and wherein the control board further includes an accelerometer, a controller coupled to the accelerometer and coupled to the ASIG connectors, and a motor driver coupled to the controller and to the stepper motor.

9. A panel antenna comprising:
a. a plurality of radiating elements;
b. an input;
c. a first feed network coupling the input to a first set of dipoles of the plurality of radiating elements, the first feed network comprising a plurality of transmission lines and at least a first variable element, the first variable element including a rotatable component; and
d. an actuator according to claim 1, wherein the drive shaft physically engages the rotatable component of the variable element.

10. The panel antenna of claim 9, further comprising a second feed network coupling a second input to a second set of dipoles of the plurality of radiating elements, the second feed network comprising a plurality of transmission lines and at least a second variable element, the second variable element being mechanically coupled to the first variable element.

11. An actuator, comprising:
a. a base plate;
b. a stationary ring gear, on the base plate, the ring gear having an arc of approximately 180°;
c. a pivot assembly, pivotally mounted on the base plate, the pivot assembly having:
i. a pivot bracket comprising a drive shaft having an axis parallel to a pivot of the pivot assembly;
ii. a control board mounted on the pivot bracket, the control board including an accelerometer, a controller coupled to the accelerometer, and a motor driver coupled to the controller; and
iii. a stepper motor and a drive gear coupled to an output shaft of the stepper motor, the stepper motor coupled to the motor driver and the drive gear mounted on the pivot bracket such that the drive gear engages the stationary ring gear;
wherein the controller is configured to obtain information from the accelerometer indicative of a physical angle of the pivot assembly, and the controller is further configured to operate the stepper motor until the pivot assembly reaches a desired physical angle with respect to vertical.

12. The actuator of claim 11, wherein the pivot assembly further comprises a worm gear and a spur gear, wherein the worm gear is located on the output shaft of the stepper motor, the worm gear engages the spur gear, and the spur gear is coupled to the drive gear.

13. A panel antenna comprising:
a. a plurality of radiating elements;
b. an input;
c. a first feed network coupling the input to a first set of dipoles of the plurality of radiating elements, the first feed network comprising a plurality of transmission lines and at least a first variable element, the first variable element including a rotatable component; and
d. an actuator according to claim 11, wherein the drive shaft physically engages the rotatable component of the variable element.

14. The panel antenna of claim 13, further comprising a second feed network coupling a second input to a second set of dipoles of the plurality of radiating elements, the second feed network comprising a plurality of transmission lines and at least a second variable element, the second variable element being mechanically coupled to the first variable element.
